(19) United States
(12) Patent Application Publication
(10) Pub. No.: US 2015/0215013 A1
(43) Pub. Date: Jul. 30, 2015

(54) METHOD AND APPARATUS FOR A MULTI-USER MULTIPLE INPUT MULTIPLE OUTPUT (MU-MIMO) NETWORK WITH SINGLE TRANSCEIVER SUBSCRIBER MODULES

(71) Applicant: Cambium Networks Limited, Ashburton (GB)

(72) Inventors: Peter Strong, Ashburton (GB); John F. Ley, Oregon, IL (US)

(21) Appl. No.: 14/166,489

(22) Filed: Jan. 28, 2014

(51) Int. Cl. H04B 7/04; H04B 7/10

(52) U.S. Cl. CPC H04B 7/0452; H04B 7/10; H04W 88/02

(57) ABSTRACT

In a multi-user multiple input multiple output (MU-MIMO) wireless network comprising an access point and several subscriber modules, a subscriber module configured with a single transceiver and two antennas elements operates a polarization switch to cause one of the two antenna elements to be connected with the single transceiver. The polarization switch may be operated in response to receiving a command from the access point. A scheduler in the access point is configured to send the command to cause the subscriber module to operate the polarization switch.

### TECHNICAL FIELD

The present disclosure relates generally to wireless communication systems using space and/or polarization division multiplexing, and more specifically, but not exclusively, to MU-MIMO (Multiple User Multiple Input Multiple Output) fixed wireless access systems having single transceiver subscriber modules.

### BACKGROUND

Modern wireless communications networks are typically placed under great demands to provide high data capacity within the constraints of the allocated signal frequency spectrum. In cellular wireless communications networks, capacity may be increased by re-using frequencies between cells, typically according to a predetermined frequency re-use pattern. Capacity may be further increased within a cell by using a space and/or polarization division multiplexed wireless network using Space Division Multiple Access (SDMA) techniques, in which orthogonal beams are typically generated to allow communication between a base station, which may be referred to as an access point, and several spatially separated user equipment, which may be referred to as subscriber modules, typically using the same frequencies at the same time to provide orthogonal channels. Typically the access point is equipped with multiple antennas, for use in forming beams on transmit and/or receive, and each subscriber module has one or more antennas. Such a wireless communications network may be referred to as MU-MIMO (Multiple User Multiple Input Multiple Output) wireless network.

A fixed wireless access system may be configured as a MU-MIMO network, and may comprise an access point, typically mounted on an antenna tower, and a number of subscriber modules installed at customer premises. The polarization of antennas at subscriber modules may be set up on installation, for example by fixing the antenna and/or subscriber module to a wall of a house. Systems are known in which each subscriber module has two orthogonal antenna elements, each receiving a substantially orthogonal polarization, each antenna element being connected to a respective transceiver chain. Signals transmitted and/or received by the two transceiver chains may be combined to allow transmission and/or reception at an arbitrary polarization. This system allows two data streams to be transmitted to each of several subscriber modules simultaneously; in effect, two beams at orthogonal polarizations may be transmitted to each subscriber module. If the access point has n antenna elements, in principle n beams may be transmitted, so data may be transmitted to n/2 subscriber modules, each receiving two data streams simultaneously.

However, the transceiver chains may be expensive, in particular for systems intended for higher frequency operation, for example at greater than 6 GHz, and so it may be advantageous to use a single transceiver chain. A single transceiver chain may be provided with a single antenna element at a fixed polarization. Such a system would allow a single data stream per subscriber unit to be transmitted to several subscriber units simultaneously, each subscriber unit receiving a beam. This has the advantage of lower cost than systems using dual transceiver chains at the subscriber module, and although only a single beam is transmitted to each subscriber module, the n beams generated by n antenna elements at the access point may, in favorable circumstances, be transmitted simultaneously to n subscriber modules, so there is the potential to maintain the system throughput of the dual transceiver system. However, in practice, system throughput may be reduced due to interference between beams to the particular locations and at the particular polarizations of subscriber modules intended to be used simultaneously.

It is an object of the disclosure to mitigate the problems of the prior art.

### SUMMARY

In a first exemplary embodiment, there is a method of operating a subscriber module in a Multi-User Multiple Input Multiple Output (MU-MIMO) network comprising an access point and a plurality of subscriber modules, wherein the subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the method comprising:

setting the polarization selection switch at the subscriber module to select the first antenna element;

receiving at the subscriber module, using the first polarization, a command from the access point instructing the subscriber module to use the second polarization for reception;

in dependence on receiving the command, setting the polarization selection switch at the subscriber module to select the second antenna element in response to the command.

This allows the polarization at which the first subscriber module transmits and/or receives to be controlled by the access point to reduce interference with other signals transmitted or received by the access point to or from other subscriber modules. The access point may have information regarding the scheduling and propagation conditions to each subscriber module, and so scheduling of data transmission may be arranged to include control of polarization, to reduce interference between beams and to increase overall system throughput.

In a second exemplary embodiment, there is subscriber module for use in a Multi-User Multiple Input Multiple Output (MU-MIMO) wireless network, the MU-MIMO network comprising an access point and a plurality of subscriber modules, the subscriber module comprising:

a first antenna element for transmitting and receiving using a first polarization;

a second antenna element for transmitting and receiving using a second polarization substantially orthogonal to the first polarization;

a polarization selection switch arranged to connect one or other of the antenna elements to a single transceiver chain; and

a controller configured to set the polarization selection switch at the subscriber module to select the first antenna element, to control the subscriber module to receive, using the first polarization, a command from the access point indicating that the subscriber module should use the second polarization for reception, and, in dependence on receipt of the command, to set the polarization selection switch at the subscriber module to select the second antenna element in response to the command.

In a third exemplary embodiment, there is method of operating an access point in a Multi-User Multiple Input Multiple Output (MU-MIMO) wireless network comprising the access point and a plurality of subscriber modules, wherein at least a first subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the method comprising:

sending a command from the access point to the first subscriber module instructing the first subscriber module to use a first specified polarization in response to the command.

In a fourth exemplary embodiment, there is an access point for use in a Multi-User Multiple Input Multiple Output (MU-MIMO) network comprising the access point and a plurality of subscriber modules, wherein at least a first subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the access point comprising:

a scheduler configured to send a command from the access point to the first subscriber module instructing the first subscriber module to use a first specified polarization in response to the command.

In a fifth exemplary embodiment, there is a space and polarization division multiplexed wireless system comprising an access point and a plurality of subscriber modules,

wherein at least a first subscriber module of the plurality of subscriber modules comprises:

a first antenna element for transmitting and receiving using a first polarization;

a second antenna element for transmitting and receiving using a second polarization substantially orthogonal to the first polarization;

a polarization selection switch arranged to connect one or other of the antenna elements to a single transceiver chain; and

a controller configured to set the polarization selection switch at the subscriber module to select the first antenna element, to control the subscriber module to receive, using the first polarization, a command from the access point indicating that the subscriber module should use the second polarization for reception and in dependence on receipt of the command, to set the polarization selection switch at the subscriber module to select the second antenna element in response to the command,

and wherein the access point comprises a scheduler configured to send a command from the access point to at least the first subscriber module instructing the first subscriber module to use a first specified polarization in response to the command.

Further features of the disclosure will be apparent from the following description of preferred embodiments, which are given by way of example only.

### BRIEF DESCRIPTION OF THE DRAWINGS

FIG. 1 is a schematic diagram showing a MU-MIMO (Multiple User Multiple Input Multiple Output) fixed wireless access system having single transceiver subscriber modules with a polarization switch controlled by the access point according to an embodiment;

FIG. 2 is a schematic diagram showing a MU-MIMO (Multiple User Multiple Input Multiple Output) wireless system having single transceiver subscriber modules according to the prior art;

FIG. 3 is a schematic diagram showing an access point and subscriber modules in an embodiment;

FIG. 4 is a schematic diagram showing a MU-MIMO (Multiple User Multiple Input Multiple Output) fixed wireless access system in an embodiment; and

FIG. 5 is a flow diagram showing a method according to an embodiment.

### DETAILED DESCRIPTION

By way of example, embodiments will now be described in the context of a MU-MIMO (Multiple User Multiple Input Multiple Output) fixed wireless access system. However, it will be understood that this is by way of example only and that other embodiments may involve other wireless systems and frequencies, and embodiments are not restricted to a specific frequency band of operation or a specific standard, and may involve operation in licensed or unlicensed bands.

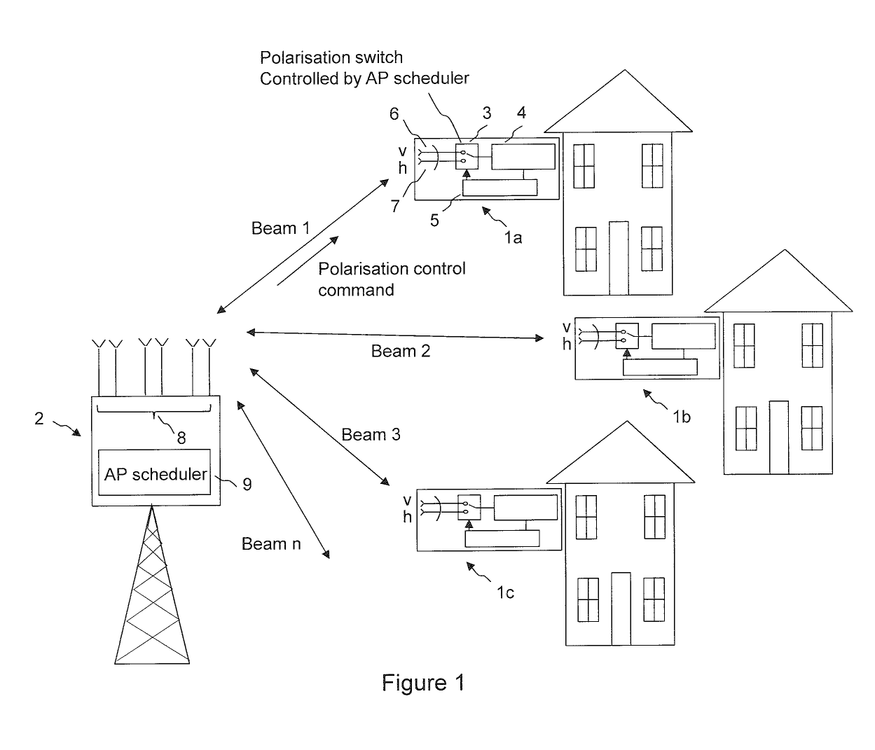

FIG. 1 is a schematic diagram showing a MU-MIMO (Multiple User Multiple Input Multiple Output) fixed wireless access system according to an embodiment, using space and/or polarization division multiplexing to allow simultaneous communication between an access point and subscriber modules by the use of orthogonal beams formed to and/or from the subscriber modules. A subscriber module may be referred to as a user equipment, and in a fixed wireless access system the subscriber module may be typically mounted to a structure such as a building, typically on the outside of a building in a position that gives good radio reception to an access point. The access point may be located at a convenient point to serve a number of subscriber units. For example the access point, or the antennas for the access point, may be mounted on an antenna tower, and may provide Internet access to a neighborhood.

As shown in FIG. 1, the wireless network has single transceiver subscriber modules 1a, 1b, 1c. A single transceiver typically includes a single series of radio frequency and baseband components for transmission known as a transmission chain, and a single series of radio frequency and baseband components for reception known as a reception chain. Each single transceiver subscriber module is equipped with a polarization selection switch 3. This is in contrast to a dual transceiver subscriber module in which each of the transceivers is permanently connected to a respective antenna element. The polarization selection switch is controlled by a command sent from a scheduler 9, the scheduler being at the access point 2. This allows the polarization at which each subscriber module transmits and/or receives using the single transceiver to be controlled by the access point, and the polarizations may be arranged to reduce interference with other signals transmitted or received by the access point to or from other subscriber modules. The access point typically has information regarding the scheduling and propagation conditions to each subscriber module, and so by including control of polarization in scheduling of data transmissions, interference between beams used simultaneously may be reduced and overall system throughput may be increased on the basis of this information. The scheduler may determine which subscriber modules form part of a MU-MIMO group which is spatially and polarization multiplexed to share the same time and frequency resource. Members of a group may be selected on the basis of which combination of group members allows mutually orthogonal beams to be formed with appropriately selected polarization, and on the basis of traffic demands. This embodiment is particularly suited to situations in which line of sight (LOS) or near line of sight (NLOS) propagation conditions prevail, so that fluctuations in polarization caused by changing multi-path conditions have reduced impact. Such conditions may be expected, for example, in systems operating with transmission above 6 GHz, but systems operating below 6 GHz may also achieve line of sight or near line of sight conditions. An embodiment may be a mixed system comprising LOS and NLOS subscriber modules. Subscriber modules capable of using MU-MIMO may do so, and the other subscriber modules may use SU-MIMO.

As shown in FIG. 1, a subscriber module 1a may be operated in a space and/or polarization division multiplexed wireless network, which may be referred to as a MU-MIMO network or MU-MIMO system, comprising an access point 2 and a plurality of subscriber modules 1a, 1b, 1 c. A plurality of beams, shown as Beam 1 to Beam n, are formed to allow respective data to be sent to respective subscriber modules simultaneously. The subscriber module 1a has a first antenna element 6 for transmitting and receiving using a first polarization, a second antenna element 7 for transmitting and receiving using a second polarization substantially orthogonal to the first polarization, and a polarization selection switch 3 arranged to connect one or other of the antenna elements to a single transceiver chain 4. The polarization selection switch may be a radio frequency switch, for example using PIN (P-type Intrinsic N-type) diode, FET (Field Effect Transistor) or other semiconductor or electromechanical technology. An “antenna element” means all or part of an antenna for transmitting or receiving on a single polarization. For example, the antenna in FIG. 1 may have an aperture defined for example by a reflector, and each antenna element 6, 7 may comprise a probe for receiving a respective polarization from the aperture. The antenna is typically installed so as to align the peak of the transmit/receive radiation pattern in the direction of the access point 2. In this arrangement, the network may be described as a Multi-User Multiple Input Multiple Output (MU-MIMO) network, in the sense that more than one subscriber module may communicate with the access point at the same time using different beams, and since the access point has more than one antenna, and the subscriber modules within a MU-MIMO group have at least one antenna each, so that the MU-MIMO group may be said to have multiple antennas.

In operation, the polarization selection switch 3 at the subscriber module 1a is set to select one of the antenna elements, for example the first antenna element 6, as shown in FIG. 1. It may then be determined that overall system throughput could be increased by changing the polarization used by the first subscriber module. Using the currently selected first polarization, a command sent from the access point is received at the subscriber module, instructing the subscriber module to use the second polarization for reception instead of the first polarization. In response to receiving the command, the polarization selection switch at the subscriber module is set to select the second antenna element. The access point may control allocation of polarization on a timeslot-by-timeslot basis, so that the command instructs the subscriber module to use the second polarization within a specified timeslot. A timeslot may be any period of time determined, for example, by the access point, and may be one or more respective transmit or receive periods in a time division duplex system. In this way, the access point may allocate polarization to subscriber units and change the allocation with time, for example to allocate polarizations in order to reduce interference occurring for a particular pattern of data usage. For example, closely spaced or co-located subscriber modules may be allocated substantially orthogonal polarizations if the subscriber modules are in use to transfer data simultaneously. The command sent to the one or more subscriber modules may comprise a map indicating a scheduling of radio resource and polarization to at least the subscriber module as a function of time. The map is a convenient way of communicating the allocation of polarization to a subscriber unit. The map may indicate respective allocations to several subscriber units as a function of time, typically all subscriber units served by an access point. The map may indicate, for example, time, polarization, and/or frequency allocation for transmission and/or reception.

The scheduling of radio resource and polarization may be updated periodically, the period between updates being determined by a scheduler at the access point. The determination may be on the basis of a coherence time of data utilization. This allows the scheduler to reduce signaling overhead by setting a period between updates in dependence on an estimate of how frequently data utilization is changing. For example, if the data utilization is video streaming, then the utilization may be relatively stable for tens of seconds, and typically the period between updates is greater than one second. The scheduling of polarization may be changed on the basis of detection of a change in data use, so that a scheduler may respond to a detection of a change in data use, such as for example a start or end of a data streaming activity, by changing an allocation of polarity. For example, approximately orthogonal polarizations may be allocated to co-located or closely spaced subscriber units both showing heavy data usage to facilitate the generation of mutually orthogonal beams to the two subscriber units.

A scheduler may be implemented as all or part of a processor or controller. The scheduler need not be an entity physically located at an access point but could be a function of a processor located remotely from the access point, for example at a node of a data network comprising several access points. The processor or controller comprising the scheduler may comprise at least one data processor, and at least one memory including computer program code, and/or may comprise a logic array such as a Field Programmable Gate Array.

A space division multiple access system, which may be a MU-MIMO network, may operate on the downlink from the access point to the subscriber modules, or on the uplink from the subscriber modules to the access point, or both. In the case of operation on the downlink, the specified timeslot is a downlink timeslot, so that data may be received at the subscriber module from the access point using the second polarization within the specified timeslot. In the case of operation on the uplink, the specified timeslot is an uplink timeslot, and data is transmitted from the subscriber module to the access point using the second polarization within the specified timeslot.

As shown in FIG. 1, a subscriber module may comprise a first antenna element 6 for transmitting and receiving using a first polarization, shown as vertical polarization, a second antenna element 7 for transmitting and receiving using a second polarization substantially orthogonal to the first polarization, shown as horizontal polarization, and a polarization selection switch 3 arranged to connect one or other of the antenna elements to a single transceiver chain. Other orthogonal or near orthogonal polarization states may be used, such as nominally +45 degrees and −45 degrees, or left and right circular polarization. As also shown in FIG. 1, the subscriber module may include a controller 5 that is configured to control the polarization selection switch in dependence on the reception of a command by the transceiver 4. The controller, which may be referred to as a processor, may comprise at least one data processor, and may comprise at least one memory including computer program code, and/or may comprise a logic array such as a Field Programmable Gate Array. The controller is configured to set the polarization selection switch at the subscriber module to select the first antenna element, to control the subscriber module to receive, using the first polarization, a command from the access point indicating that the subscriber module should use the second polarization for reception, and in dependence on receipt of the command, to set the polarization selection switch at the subscriber module to select the second antenna element in response to the command.

The access point is configured to send a command to at least the first subscriber module instructing the first subscriber module to use a first specified polarization in response to the command. The command may instruct the subscriber module to use the second polarization within a specified timeslot. The access point may also send a command to a second subscriber module instructing the second subscriber module to use a second specified polarization within the specified timeslot. The command may also be referred to as a message,

In the case that the specified timeslot is a downlink timeslot, the access point transmits data to the first subscriber module using a first beam, the first beam being arranged to have the first specified polarization on receipt at the first subscriber module within the specified timeslot. The access point also transmits data to the second subscriber module using a second beam, the second beam being arranged to have the second specified polarization on receipt at the second subscriber module within the specified timeslot. This arrangement of the beams in terms of relative polarization facilitates the generation of the first and second beams in a way that one is orthogonal, or has reduced interference, to the other on reception at the first and second subscriber module.

On the uplink also, reception beams may be arranged to receive signals at a given polarization from the first subscriber module and at an orthogonal polarization from the second subscriber module. So, in the case that the specified timeslot is an uplink timeslot, data is received at the access point from the first subscriber module using a third beam arranged to receive a signal transmitted with the first specified polarization from the first subscriber module within the specified timeslot, and data is received from the second subscriber module at the access point using a fourth beam arranged to receive a signal transmitted with the second specified polarization from the second subscriber module within the specified timeslot.

The access point and a plurality of subscriber modules may be referred to as at least part of a space division multiplexed wireless system, or at least part of a MU-MIMO network.

In the arrangement shown in FIG. 1, each subscriber module has a single transceiver 4. This may offer reduced cost compared with the situation where one transceiver is provided per polarization, and may be particularly advantageous for operation at higher frequencies, for example above 6 GHz, since at higher frequencies a transceiver chain may be more expensive than a transceiver chain at lower frequencies, and may for example include relatively expensive waveguide components, but cost advantages also apply at frequencies less than 6 GHz. A transceiver includes a transmitter chain and a receiver chain. A transmitter chain typically has a series of components including an upconverter and power amplifier, and a receiver chain typically has a series of components including a low noise amplifier and downconverter. A transceiver may be arranged to alternate between transmission and reception to give two way transmission using the same frequency in a Time Division Duplex (TDD) system.

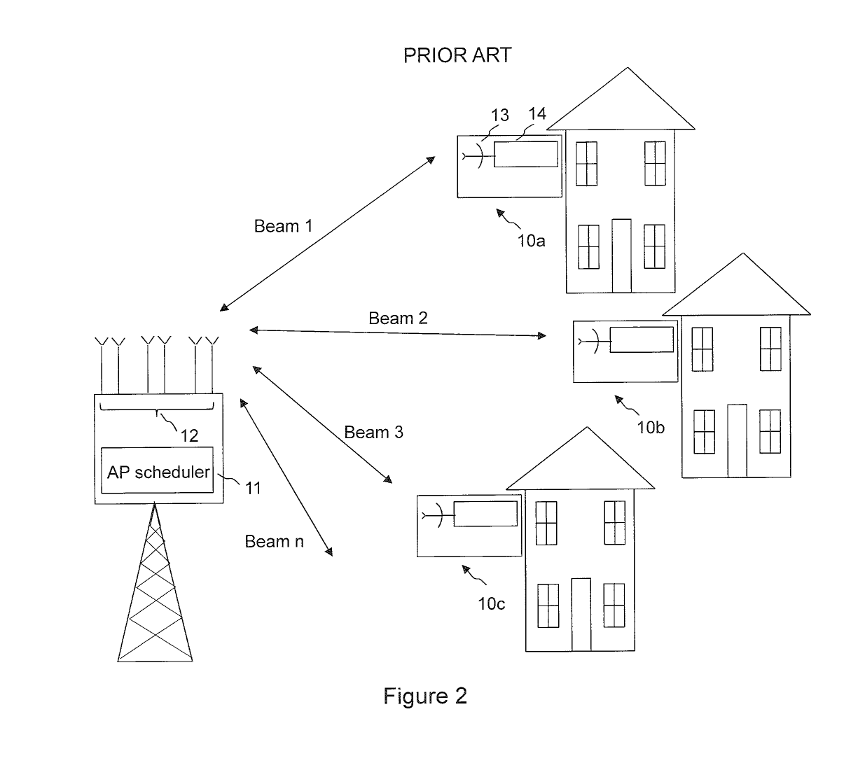

FIG. 2 illustrates a prior art system, in which user equipment has a single transceiver 14 and single antenna 13. An access point scheduler schedules data to transmit and receive timeslots, for transmission or reception by the antenna array 12 at the access point.

Prior art systems are known in which a polarization or space diversity switch is controlled by a user equipment. The user equipment may select a polarization which gives the best transmission characteristics between the user equipment and an access point. Typically a user equipment may be mobile, for example a hand held device or lap top computer, and so the orientation of the antenna would be expected to move with time, on occasions quite rapidly, and so the polarization or space diversity switch continually selects the best polarization under local control at the user equipment. An example of such a system is the antenna selection (ASEL) feature provided for IEEE 802.11n SU-MIMO (Single User MIMO) networks. A user equipment station initiates channel sounding to determine which polarization of antenna to use, and the user equipment determines which polarization to use as a result of channel measurements made as a result of the sounding. This is in contrast to embodiments in which a polarization selection switch at a subscriber module is under control of the access point scheduler. This is particularly advantageous when the subscriber module is installed at a fixed orientation, for example fixed externally to a building, for example by an adjustable bracket, and particularly for line-of-sight links. In this situation, the polarization of the link between the access point and the subscriber module would be expected to be relatively stable with time. Scheduling of the polarization by the access point scheduler may then be determined in the expectation that the propagation conditions in terms of polarization would persist, so that advantageous allocations of polarization to beams and subscriber modules may be exploited.

Some improvement in performance over the prior art system shown in FIG. 2 may be achieved by equipping each subscriber module to exploit polarization diversity, by providing two antenna elements at orthogonal polarizations, and a polarization selection switch to connect one or other of the antenna elements to the transceiver chain, with the polarization switch under control of the subscriber module. The subscriber module would select the polarization to provide the best signal quality for reception and for transmission based on measurements of the quality of the channel between the access point and the subscriber module. However, the polarization selected by such a system, although it may be best for use at the subscriber module which selects it, may cause interference to a link to or from other subscriber modules, and so system throughput may be sub-optimal.

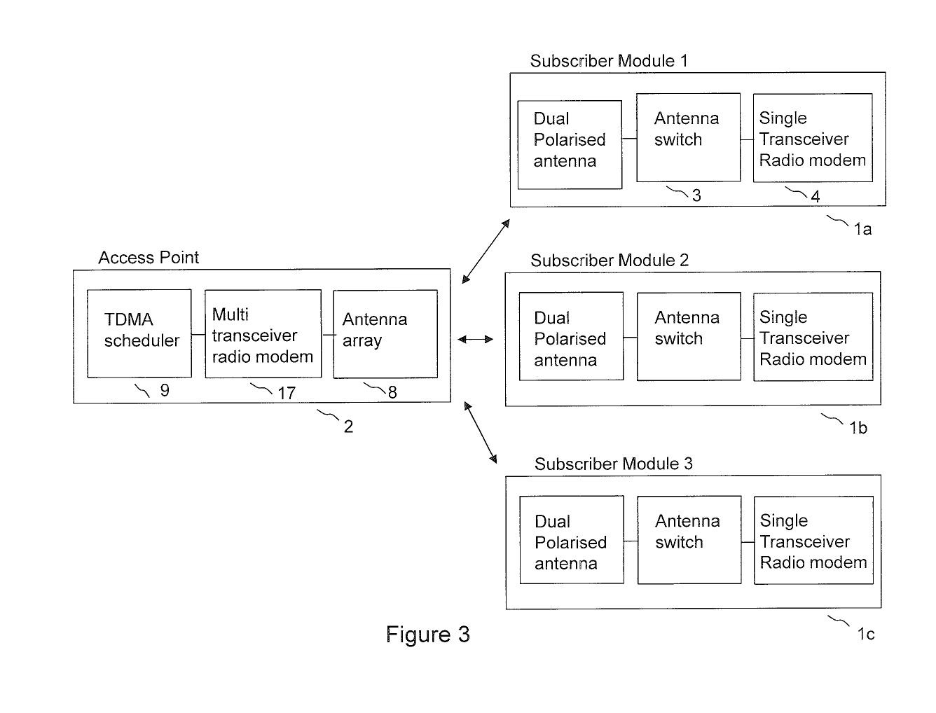

FIG. 3 shows an access point and subscriber modules according to an embodiment. It can be seen that in an embodiment, an access point comprises a Time Division Multiple Access (TDMA) scheduler 9. The TDMA scheduler typically schedules data transfer between subscriber units according to time and also schedules data transfer according to spatial beams, that is to say it has a Space Division Multiple Access (SDMA) function also. The scheduler is connected to a multi-transceiver radio modem 17, typically providing a transceiver for each antenna element of an antenna array 8. The antenna array has an arrangement of antenna elements separated in space, for example spaced apart by 1 wavelength at an operating frequency of the antenna array. Typically, at each spatial location, antenna elements at two orthogonal polarizations are provided, for example nominally vertical and horizontal polarization or left-hand and right-hand circular polarization. The amplitude and phase of the signal applied to each antenna element may be controlled in such a way as to form a beam in the direction of a subscriber module with which communication is intended. A weight set of amplitude and phase weights, typically expressed as inphase and quadrature components, may be referred to as a pre-coding matrix. Each beam typically has a respective precoding matrix, which may determine the polarization of a beam in addition to its direction by appropriate weighting of antenna elements of different polarizations. The precoding matrix may be adjusted according to feedback from a subscriber module, for example feedback of received channel state information or signal strength or signal quality, in order to adjust the transmit beam direction and polarization on the downlink for improved reception. In a time division duplex system, at which transmission and reception is at the same frequency, the approximate reciprocity of propagation in the uplink and downlink may be exploited to allow the weightset for the downlink to be adjusted on the basis of measurements of signal reception on the uplink. A weightset applied to signals received by each antenna element at the access point on the uplink may also be adjusted to adjust a receive beam direction and polarization. This may be done on the basis of received signal strength or signal quality of signals received at the access point from a subscriber module. The precoding matrix may also be used to correct for non-ideal orthogonality of the antennas. This may be done on the basis of channel state information maintained at the access point for each subscriber module for each state of the antenna switch.

FIG. 3 also shows that in an embodiment, each subscriber module 1a, 1b, 1c comprises a dual polarized antenna, typically comprising two antenna elements arranged to transmit and receive at mutually orthogonal polarizations, which are switched by an antenna switch 3, also referred to as a polarization selection switch, for connection to a single transceiver radio modem 4. A radio modem typically comprises a modulator and transmit chain, and a receive chain and demodulator.

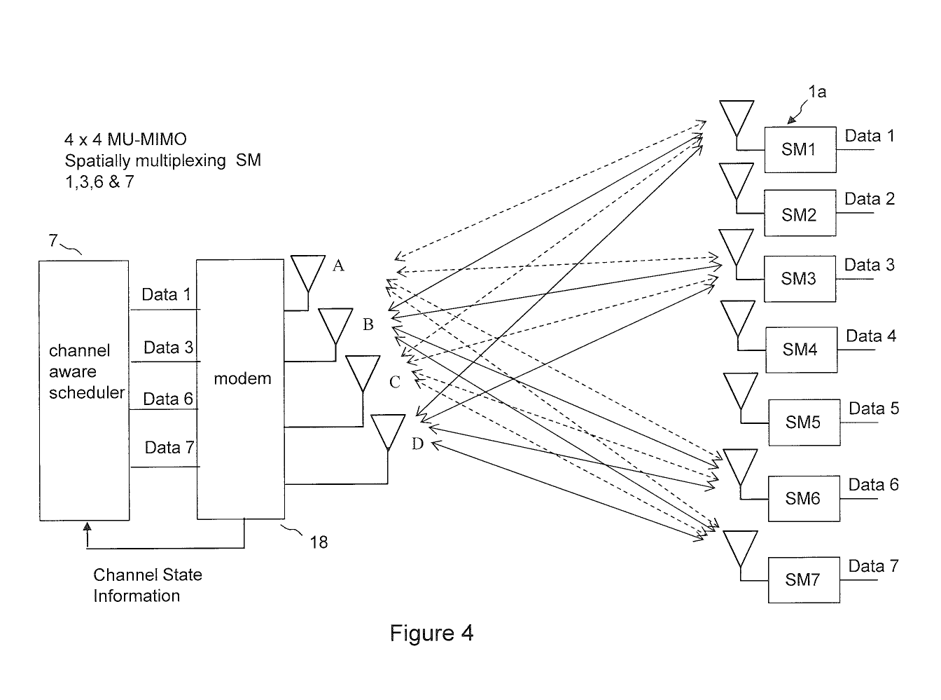

FIG. 4 is a schematic diagram showing a MU-MIMO (Multiple User Multiple Input Multiple Output) fixed wireless access system in an embodiment. In the example of FIG. 4, four beams are formed to subscriber modules SM1, SM3, SM6 and SM7 respectively. This allows different data to be sent in each of the four beams simultaneously. For example data stream Data 1 may be used to modulate a signal, for example using Quadrature Amplitude Modulation (QAM), and the modulated signal may be split into, in this example, four components (or the four components may be generated and modulated independently), and each component may be weighted by a respective term of the precoding matrix, and may be upconverted by the multitransceiver modem 18 for transmission by a respective antenna element. The channel aware scheduler 7 uses, in this example, channel state information from uplink signals received at the access point to adjust the beams on the uplink and/or downlink and schedule the simultaneous use of beams that are determined to be orthogonal or at least approximately so.

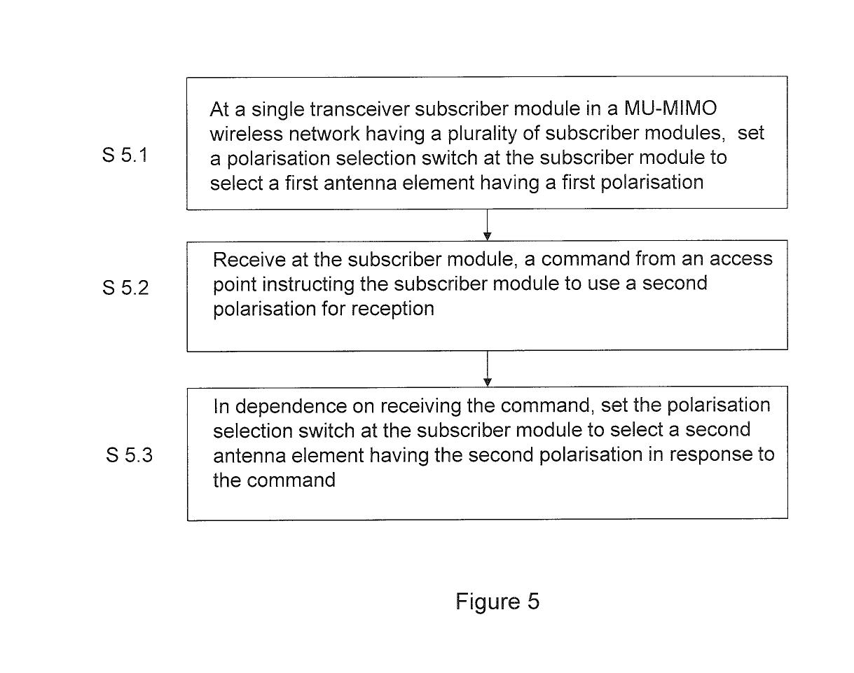

FIG. 5 is a flow diagram showing a method according to an embodiment. At step S5.1, a polarization switch at a subscriber module is set to select a first antenna element having a first polarization for connection to a transceiver. The subscriber module is a single transceiver subscriber module and is in a MU-MIMO network having a plurality of subscriber modules. The switch may, for example, be set in response to receipt of a previous command from an access point, or it may be set as a start up condition. At step S5.2, a command is received at the subscriber module that is transmitted from an access point which instructs the subscriber module to use a second polarization for reception. The command may also instruct the subscriber module to use the second polarization for transmission. For example, in a time division duplex system, the transmit and receive polarization may be the same. At step S5.3, the polarization selection switch at the subscriber module is set, in dependence on receiving the command, to select a second antenna element having a second polarization for connection to the transceiver, in response to the command.

As has been mentioned, embodiments described above relate to Multi-User MIMO (MU-MIMO) systems comprising user equipment with a single transceiver, in which an Access Point (AP) scheduled antenna switch is included with MU-MIMO user equipment (UE). The user equipment may also be referred to as a subscriber module. So, the MU-MIMO system includes single transceiver user equipment with dual polarization antennas and an antenna switch to select the antenna polarization. The antenna selection is under control of the Access Point (AP) scheduler. The access point scheduler determines whether a user equipment uses the first or second polarization for either transmission or reception of data. The antenna polarization used by the user equipment may be dynamically selectable, under control of the scheduler in the access point. This may allow lower user equipment cost and power consumption while maintaining aggregate throughput of data at an access point. Access point throughputs may be similar to what is achieved using dual transceiver user equipment where the throughput is limited by the access point and not the user equipment. The technique is particularly appropriate for, but not limited to, a Line-of-Sight MU-MIMO (LOS-MU-MIMO) system and/or where the transceiver costs are high such as with technology for operation at greater than 6 GHz. In addition to limiting the user equipment to a single RF (radio frequency) transmit chain and a single RF receive chain, a single transceiver demodulator typically only processes a 1×1 channel estimate reducing logic requirements and power consumption.

A MU-MIMO system may comprise an access point with multiple user equipment. The access point may schedule more than one user equipment to be active using the same time and frequency resource. The system may include multiple single transceiver user equipment, each with one transmit chain and one receiver chain. A chain comprises the RF and baseband circuitry. The user equipment includes a dual polarization antenna providing two orthogonal polarizations, both having the same bore sight, that is to say both providing a beam in the same direction. The two polarizations may include V (vertical) or H (horizontal) and left or right handed circular polarizations. In principle, orthogonal polarizations can be provide in the same antenna aperture with no reduction in gain although in practice the more complicated antenna feed may result in some additional degradation.

In the user equipment, an antenna switch selects which polarization is fed to the transceiver. The switch selection is under fast or slow control of the access point, for example slow control involving updating the scheduling of radio resource and polarization periodically with a period between updates being greater than one second in one example and greater than ten seconds in another example. The access point scheduler controls the polarization used by each user equipment for data transmission or reception. Fast control of the user equipment antenna polarization switch may be provided by an extension to a downlink and uplink map. Typically downlink and uplink maps are broadcast by an access point to indicate which time and frequency resources are to be used by user equipment under control of the access point. The extension to the map determines which polarization is to be used by specific user equipment. Alternatively the polarization selection could be on a slower timescale but still under control of the access point. For traffic patterns showing long term coherence across multiple user equipment such as video traffic, slow control of the polarization selection may provide useful performance gains. The access point may arrange the selection of polarization in dependence on an amount of data to be sent to respective subscriber modules, to provide mutually orthogonal beams to a pair of subscriber modules to which a relatively large amount of data is to be sent compared with the amount of data to be sent to other subscriber modules.

So, in an embodiment, a single transmit/receive (TX/RX) chain is provided with a switched polarization antenna. Simultaneously communications may be supported with two collocated or closely located subscriber modules using separate polarizations and the same aggregate access point throughput may be maintained compared to a single dual polar access point. The system is particularly applicable, but not limited to, static or near-static Line-of-Sight/Near Line-of-Sight (LOS/nLOS) channels with long channel coherence times, which may be greater than a minute or longer. A channel coherence time is a time over which channel conditions do not change substantially.

The term MU-MIMO (Multiple User Multiple Input Multiple Output) may refer to technologies where the available antennas are spread over several radio terminals each having one or more antennas and a single access point having multiple antennas. The term may also be used to refer to systems having several radio terminals and several access points, each radio terminal or access point having one or multiple antennas. By contrast, the term Single User MIMO may be used to refer to a single multi-antenna transmitter communicating with a single multi-antenna receiver. To enhance the communication capabilities of terminals, MU-MIMO may apply an extended version of space-division multiple access (SDMA) to allow multiple transmitters to send separate signals and multiple receivers to receive separate signals simultaneously in the same band.

The above embodiments are to be understood as illustrative examples. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of operating a subscriber module in a Multi-User Multiple Input Multiple Output (MU-MIMO) wireless network comprising an access point and a plurality of subscriber modules, wherein the subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the method comprising:
setting the polarization selection switch at the subscriber module to select the first antenna element;
receiving at the subscriber module, using the first polarization, a command from the access point instructing the subscriber module to use the second polarization for reception;
in dependence on receiving the command, setting the polarization selection switch at the subscriber module to select the second antenna element in response to the command.

2. The method of claim 1, wherein the command instructs the subscriber module to use the second polarization within a specified timeslot.

3. The method of claim 2, wherein the specified timeslot is a downlink timeslot, and the method comprises:
receiving data at the subscriber module from the access point using the second polarization within the specified timeslot.

4. The method of claim 2, wherein the specified timeslot is an uplink timeslot, and the method comprises:
transmitting data from the subscriber module to the access point using the second polarization within the specified timeslot.

5. The method of claim 1, wherein the command is generated on the basis of a scheduling of radio resource and polarization to at least the subscriber module as a function of time.

6. The method of claim 1, wherein the command comprises a map indicating a scheduling of radio resource and polarization to at least the subscriber module as a function of time.

7. The method of claim 5, comprising updating the scheduling of radio resource and polarization periodically, wherein a period between updates is determined by a scheduler at the access point on a basis including a coherence time of data utilization.

8. The method of claim 7, wherein the period between updates is greater than one second.

9. The method of claim 5, comprising changing a scheduling of polarization on the basis of detection of a change in data use.

10. The method of claim 1, wherein the wireless network is a fixed wireless access system.

11. A subscriber module for use in a Multi-User Multiple Input Multiple Output (MU-MIMO) wireless network, the MU-MIMO network comprising an access point and a plurality of subscriber modules, the subscriber module comprising:
a first antenna element for transmitting and receiving using a first polarization;
a second antenna element for transmitting and receiving using a second polarization substantially orthogonal to the first polarization;
a polarization selection switch arranged to connect one or other of the antenna elements to a single transceiver chain; and
a controller configured to set the polarization selection switch at the subscriber module to select the first antenna element, to control the subscriber module to receive, using the first polarization, a command from the access point indicating that the subscriber module should use the second polarization for reception, and, in dependence on receipt of the command, to set the polarization selection switch at the subscriber module to select the second antenna element in response to the command.

12. A method of operating an access point in a Multi-User Multiple Input Multiple Output (MU-MIMO) wireless network comprising the access point and a plurality of subscriber modules, wherein at least a first subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the method comprising:
sending a command from the access point to the first subscriber module instructing the first subscriber module to use a first specified polarization in response to the command.

13. The method of claim 12, wherein the command instructs the subscriber module to use the second polarization within a specified timeslot.

14. The method of claim 13, comprising:
sending a command from the access point to a second subscriber module instructing the second subscriber module to use a second specified polarization within the specified timeslot.

15. The method of claim 14, wherein the specified timeslot is a downlink timeslot, and the method comprises:
transmitting data to the first subscriber module from the access point using a first beam arranged to have the first specified polarization on receipt at the first subscriber module within the specified timeslot; and
transmitting data to the second subscriber module from the access point using a second beam arranged to have the second specified polarization on receipt at the second subscriber module within the specified timeslot.

16. The method of claim 14, wherein the specified timeslot is an uplink timeslot, and the method comprises:
receiving data from the first subscriber module at the access point using a third beam arranged to receive a signal transmitted with the first specified polarization from the first subscriber module within the specified timeslot; and
receiving data from the second subscriber module at the access point using a fourth beam arranged to receive a signal transmitted with the second specified polarization from the second subscriber module within the specified timeslot.

17. The method of claim 12, comprising generating the command on the basis of a scheduling of radio resource and polarization to at least the subscriber module as a function of time.

18. The method of claim 12, wherein the command comprises a map indicating a scheduling of radio resource and polarization to at least the first subscriber module as a function of time.

19. The method of claim 17, comprising updating the scheduling of radio resource and polarization periodically, wherein a period between updates determined by a scheduler at the access point on a basis including a coherence time of data utilization.

20. The method of claim 19, wherein the period between updates is greater than one second.

21. The method of claim 17, comprising changing a scheduling of polarization on the basis of detection of a change in data use.

22. The method of claim 12, wherein the wireless network is a fixed wireless access system.

23. An access point for use in a Multi-User Multiple Input Multiple Output (MU-MIMO) network comprising the access point and a plurality of subscriber modules, wherein at least a first subscriber module has a first antenna element for transmitting and receiving using a first polarization, a second antenna element for transmitting and receiving using a second polarization substantially orthogonal to the first polarization, and a polarization selection switch arranged to connect one or other of the antenna elements to a single transceiver chain, the access point comprising:
a scheduler configured to send a command from the access point to the first subscriber module instructing the first subscriber module to use a first specified polarization in response to the command.

24. A space and polarization division multiplexed wireless system comprising an access point and a plurality of subscriber modules,
wherein at least a first subscriber module of the plurality of subscriber modules comprises:
a first antenna element for transmitting and receiving using a first polarization;
a second antenna element for transmitting and receiving using a second polarization substantially orthogonal to the first polarization;
a polarization selection switch arranged to connect one or other of the antenna elements to a single transceiver chain; and
a controller configured to set the polarization selection switch at the subscriber module to select the first antenna element, to control the subscriber module to receive, using the first polarization, a command from the access point indicating that the subscriber module should use the second polarization for reception and in dependence on receipt of the command, to set the polarization selection switch at the subscriber module to select the second antenna element in response to the command,
and wherein the access point comprises a scheduler configured to send a command from the access point to at least the first subscriber module instructing the first subscriber module to use a first specified polarization in response to the command.
